(19) United States
(12) Patent Application Publication
(10) Pub. No.: US 2009/0150237 A1
(43) Pub. Date: Jun. 11, 2009

(54) POINTS BASED ONLINE AUCTION

(75) Inventors: Ashwini Gupta, Scarsdale, NY (US); Mikhail I. Dobrolioubov, Jersey City, NJ (US); Venkat Varadachary, New York, NY (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/060,521

(22) Filed: Apr. 1, 2008

Related U.S. Application Data
(60) Provisional application No. 61/012,674, filed on Dec. 10, 2007.

(51) Int. Cl. G06Q 30/00

(52) U.S. Cl. 705/14; 705/26

(57) ABSTRACT

A point based auction over a computerized network is disclosed wherein providers of products and/or services may bid on an opportunity to sell to a group of consumers who have indicated a desire to purchase such goods and/or services. Consumers may combine one or more loyalty accounts and the system calculates, according to a point to currency conversion, a currency value of a balance of points. The provider is able to see the currency value of the consumer's points, wherein the provider may determine to place a bid in the reverse auction. The system may not provide the consumer with access to the currency value. Both provider and consumer configure, manage, and participate in the auctions over a computerized network such as the internet.

### RELATED APPLICATIONS

This application claims priority to, and the benefit of, U.S. Provisional Ser. No. 61/012,674 filed on Dec. 10, 2007 and entitled “Points Based Online Auction”, which is hereby incorporated by reference.

### FIELD OF THE INVENTION

The present invention generally relates to a points based auction system, and more particularly, to a system and method which allows a provider of items to view the currency value of the consumer's points and place a bid to provide the desired items to the consumer.

### BACKGROUND

Providing incentives to attract consumers to purchase particular items from particular merchants is a common practice that has existed for many years. Loyalty (incentive, rewards, etc) programs have been used within the financial services industry to, for example, entice consumers to apply for a transaction account, and to use the transaction account to facilitate a purchase. Consumers are typically awarded a predetermined number of points based on a purchase amount. Consumers have grown to appreciate such loyalty programs, because the consumers earn loyalty points based on everyday purchases, then the consumers are later able to fully or partially exchange the loyalty points for items (e.g., goods and services).

Many companies have continuously pushed to develop new and unique loyalty programs to stay a step ahead of their competitors. The redemption of loyalty points to facilitate purchases has expanded to include more and more goods and service providers who partner with the loyalty point issuer or transaction account company to provide even greater incentives. Likewise, consumers often demand expanded redemption options. Consumers increasingly want fewer restrictions on how their loyalty points may be redeemed and request different ways to redeem their increasing stockpile of points. In response to consumer demand and the companies' desire to persuade consumers to use their points, companies have become more creative in offering additional avenues for loyalty point redemption.

At the same time, online auction web sites (e.g., eBay) have enjoyed increased popularity. However, the success of such online auctions has been subdued by the lack of variety in participating merchants, item offerings and the increasing monetary costs to obtain certain items. As such, there is a need for a system and method for attracting a larger number of merchants and consumers to an online auction.

### SUMMARY OF THE INVENTION

The present invention overcomes the limitations and problems of the prior art by providing a system and method for conducting a points based blind auction. In one embodiment, the system may facilitate a points based blind auction between at least one consumer and at least one provider by receiving, from a provider, an item, wherein the item is for a product and/or a service; determining a currency value of a point belonging to the consumer; communicating the currency value to the provider; receiving a bid from the provider comprising a number of points that the provider will accept in exchange for the item; determining when the bid is an optimal bid for the item; deducting a number of loyalty points from an account of the consumer when the bid is an optimal bid, wherein said currency value is unknown to said consumer; converting the loyalty points to the currency value; and crediting the currency value to an account of the provider.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is a block diagram illustrating exemplary system components for facilitating a points based blind auction, according to exemplary embodiments of the present invention;

FIG. 2 is a process flow diagram illustrating provider registration steps to participate in a points based blind auction, according to exemplary embodiments of the present invention;

FIG. 3 is a block diagram illustrating web pages enabling providers to configure and manage a points based blind auction, according to exemplary embodiments of the present invention;

FIG. 4 is a process flow diagram illustrating consumer registration steps to participate in a points based blind auction, according to exemplary embodiments of the present invention;

FIG. 5 is a block diagram illustrating web pages enabling consumers to configure and manage consumer information relative to a points based blind auction, according to exemplary embodiments of the present invention;

FIG. 6 is a process flow diagram of exemplary steps for participating in a reverse style points based blind auction, according to exemplary embodiments of the present invention; and,

FIG. 7 is a process flow diagram of exemplary steps for participating in an English style points based blind auction, according to exemplary embodiments of the present invention.

### DETAILED DESCRIPTION OF EXEMPLARY EMBODIMENTS

The detailed description herein is presented for purposes of illustration only and not of limitation. For example, the steps recited in any of the method or process descriptions may be executed in any order and are not limited to the order presented. For the sake of brevity, conventional data networking, application development and other functional aspects of the systems (and components of the individual operating components of the systems) may not be described in detail herein. References to singular include plural, and references to plural include singular.

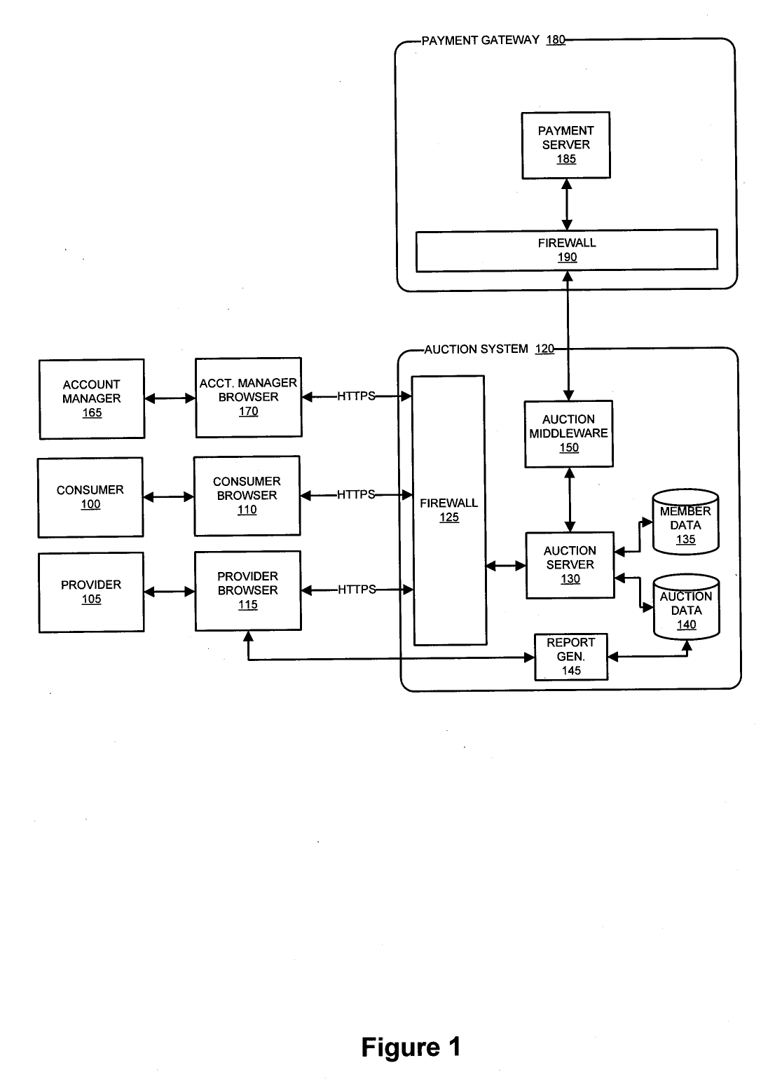

In general, with reference to FIG. 1, an auction system 120 overcomes the disadvantages of prior art systems and methods by providing a unique medium for which consumers 100 may redeem loyalty points in exchange for items. In one embodiment, the currency value of certain points is not disclosed (or is only partially disclosed) to the consumer. As discussed herein, items may include, for example, goods, services, information, offerings, entertainment, gifts, charitable contributions, events, experiences, opportunities, and/or anything desired by a participant or for a third party. As discussed in more detail below, loyalty points may include, for example, any indication of value (e.g., monetary and/or non-monetary) which may be earned or obtained in any way. The points may or may not include restrictions, may be combined with other points, transferred from or to other accounts, be converted to other values, limited to certain geographic areas, earned in one or more programs and/or the like.

The present invention may incorporate any type of advertising or marketing systems. The system may display certain advertisements or send certain advertisements to consumers or providers based on any actions related to the system. For example, the system may display an advertisement related to consumer, issuer, loyalty program and/or merchant information. The system may also display advertisements related to a certain bid, repetitive bids, a trend of bids, certain items offered for bid, items complementary to the items offered for bid, other ways to redeem loyalty points and/or the like.

Auction system 120 may be any type of auction known in the art or subsequently developed. In one embodiment, an auction system 120 provides an online reverse auction, wherein a consumer 100 may indicate a desire to purchase items from a provider 105 (merchant) providing the lowest bid. In a reverse auction scenario, merchants are more inclined to participate when they fully understand the conversion ratio of a purchaser's loyalty points. With this understanding, the merchant can more confidently place bids on individual and/or groups of loyalty account holders for the opportunity to sell items at a price that will minimize or eliminate a loss to the merchant.

Consumer 100 uses loyalty points to bid for and purchase items that are won in an auction by the consumer, by groups of consumers, or partially won (e.g., 5 tennis rackets in the auction, but the auction divides the prize among a few consumers, so one consumer only wins 2 tennis rackets). However, in one embodiment, consumer 100 is provided minimal or no information relating to the monetary value of the item which is bid upon, and/or the value of the loyalty points used for any bidding session, a particular bidding session, or a subset of sessions. Auction system 120 may minimize the disclosure of the monetary value to the consumer 100 by not disclosing any information related to the value of the item, not disclosing the UPC or SKU data, not disclosing a retail price, not disclosing where the product can be purchased, not disclosing the identity of the provider, distorting the information, converting the information to another value or format, and/or not disclosing any other information related to the item or the process.

The auction system 120 determines the appropriate point-to-currency conversion ratio based on the type of loyalty points in a consumer's loyalty account, and provides this information to the participating provider 105 (e.g., merchant that is selling the item at auction). Therefore, provider 105 is able to determine an optimal bid amount to accept for selling the item, based on the true monetary value of the consumer's loyalty points. Provider 105 may receive the value information via any communication means discussed herein or known in the art such as, for example, email, facsimile, accessing a webpage and/or the like.

The conversion ratio may be changed by any participant such as, for example, the merchant, the issuer, administrators and/or the consumer. The conversion ratio may change over a certain time period, may change based on certain input from any participant, may change based on the type or level of participant (e.g., gold level member, frequent shopper/bidder, etc), may be subject to random changes, may be based on an algorithm, may be changed based on economic factors or other factors (e.g., consumer price index), may change based on the products or services offered for bid and the like. The time periods for changing the conversion ratio may include changes prior to, during or after a certain time interval (e.g., minute, hour, day, week, etc); prior to, during or after a certain time of day; prior to, during or after certain seasons (e.g., winter, spring, summer, fall); prior to, during or after certain events (e.g., Super Bowl); prior to, during or after certain holidays (e.g., Christmas) and the like. The changes based on input from other participants include, for example, conversion ratio changes based on the number of bids, the amount of a bid, the frequency of bids, the type or level of bidders, offers to submit non-point bids (e.g., barter, monetary amounts, etc), offers to submit non-point bids in addition to point bids, and the like.

In one embodiment, the system also includes one or more account manager 165 and payment gateway 180. Auction system 120 may include, in one embodiment, one or more firewall 125, auction server 130, member data 135, auction data 140, report generator 145 and auction middleware 150. As will be appreciated by one of ordinary skill in the art, the present invention may be embodied as a customization of an existing system, an add-on product, upgraded software, a stand alone system (e.g., kiosk), a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Provider 105, as used herein, may include any individual, business, entity, group, charity, government organization, software and/or hardware suitably configured to offer items for sale within an auctioning environment in return for loyalty points (which may be exchanged for monetary value). The items may be offered in the online auction such that consumers offer to purchase an item based on loyalty points that are later converted to a currency value for payment to the provider. The provider may be a third party who interacts with the online auction through an existing shopping gateway.

A consumer 100, as used herein, may include any individual, business, entity, group, charity, software and/or hardware that desires to participate in the auction system 120 to obtain items in exchange for loyalty points that consumer 100 has obtained through purchases or any other transaction. Consumer 100 may facilitate a trade transaction by purchasing an item (from a provider 105, auction system 120 or any other entity), based on the consumer's winning bid.

An account manager 165, as used herein, may include any individual, business, entity, software and/or hardware that partially or fully owns, manages or controls the online auction. The account manager 165 may own or manage some or all of the hardware and software components of the online auction system, however this is not necessary. For example, account manager 165 may own or manage an online auction which is hosted by a third-party on a contract basis.

With continued reference to FIG. 1, the consumer 100, provider 105 and account manager 165 may interface with the system via any communication protocol, device or method discussed herein. In one embodiment, the consumer 100, provider 105 and account manager 165 may interface with the system via an internet browser. Consumer browser 110, provider browser 115 and account manager browser 170 may comprise any hardware and/or software suitably configured to facilitate input, receipt and/or review of any information related to auction system 120 or any information discussed herein. Consumer browser, provider browser 115 and account manager browser 170 may include any device (e.g., personal computer) which communicates (in any manner discussed herein) with auction server 120 via any network discussed herein. Such browser applications comprise Internet browsing software installed within a computing unit or system to conduct online commerce transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, network sets of computers, and/or the like. Practitioners will appreciate that account manager 165 may or may not interact with the auction system through a browser application, but through a host terminal or the server directly. The system may also include access rights and different levels of access to different portions of the system for different entities.

Auction server 130 may include any hardware and/or software suitably configured to facilitate management of an auction. Auction server 130 may interface directly or indirectly with consumer browser 110, provider browser 115, auction middleware 150, member database 135, and/or auction database 140. Auction server 130 may operate as a single entity in a single geographic location or as separate computing components located together or in separate geographic locations. Further, auction server 130 may be an Internet server or may send, receive and process data via a network both to and from a separate Internet server. Auction server 120 may be configured to dispatch requests to the components behind the firewall 125 which prevents direct access to the auction system 120 components. Data transmissions from the consumer browser 110, provider browser 115, and account manager browser 170 may pass through the firewall 125, and may be processed by the auction server 130 which commits data to either the member database 135 or auction database 140. For the purpose of simplicity, the member database 135 and auction database 140 are illustrated and described herein as two distinct databases. One skilled in the art will appreciate that the auction system 120 databases may be of any number of configurations. Further, as described in detail below, the member database 135 and the auction database 140 may be any type of database, such as relational, hierarchical, object-oriented, and/or the like.

Member database 135 may include any hardware and/or software suitably configured to facilitate storing consumer 100 and provider 105 information. Consumer 100 information may include, for example, names of a companies or individuals, street addresses, telephone numbers, email addresses, biographic information, credit rating, services of interest, loyalty point information, financial account information, biometric data, and/or the like. Provider 105 information may include, for example, names of a companies or individuals, street addresses, telephone numbers, email addresses, biographic information, credit rating, descriptions of services provided, financial settlement information and/or the like.

Auction database 140 may include any hardware and/or software suitably configured to facilitate storing information relating to auctions. The auction information may relate to past, present or future auctions, participants, items, bids, activities, etc. Auction database may store information originating with both consumer 100 and provider 105. Auction database 140 may include specific or general information relating to consumer 100 and/or provider 105 participation in certain auctions.

The various data elements discussed herein may include information that is received, by any means known in the art, from providers, manufacturers, credit line issuers, loyalty account administrators, merchant consortiums, etc. For example, providers may submit information relating to item offerings to auction system 120 within data packets over the Internet or any other network. Such data packets may include SKUs, UPCs, images, text, merchant identifiers, address information, contact information, merchant classifications, and the like. Data received by auction system 120 may be parsed according to data types and stored in any number of database tables and databases located within the same or different geographic areas. For example, pricing data may be stored in a separate database table than product descriptions, wherein the product price may be linked to a product description through a primary key. Moreover, point-to-currency conversion ratio data may be provided by a loyalty account administrator, parsed encrypted and stored such the conversion ratios may viewed by providers but not by consumers.

Data residing in the same or different databases and/or database tables may be aggregated as a response to, for example, a search term entered into a web interface for the disclosed auction system. The aggregation of data may include the aggregation of encrypted and decrypted data, wherein some data remains encrypted to prevent certain users from viewing the data, while other information remains decrypted, such that it is viewable to all or a subset of users. The various data elements discussed herein may be encrypted using any known encryption algorithms and schemes.

Access to the various data elements may be controlled according to rules that are applied to users based on roles. Such rules may be defined by credit line issuers, loyalty account administrators, merchant providers, auction administrators, consumers, and/or any other designated third party. Information relating to points and point values may be hidden from consumers during certain durations of an auction and may be revealed at the request of credit line issuers, providers, and the like. Likewise, information relating to any other aspect of the invention such as, for example, consumer identity, point balances, point types, point values, provider identity, credit line issuer identity may be hidden and/or revealed as defined by any party at any point during an auction.

Firewall 125 may include any hardware and/or software suitably configured to protect auction system 120 resources from users from other networks and provide limited or restricted access to consumer 100, provider 105 and account manager 165. Firewall 125 may reside in varying configurations including Stateful Inspection, Proxy based and Packet Filtering among others. Firewall 125 may be integrated within auction server 130, any other system components or may reside as a separate element.

Report generator 145 may include any hardware and/or software suitably configured to produce reports from information stored in one or more databases. Report generators are commercially available and known in the art. Report generator 145 may provide printed reports, web access to reports, graphs, real-time information, raw data, batch information and/or the like. The report generator 145 may be implemented through commercially available hardware and/or software, through custom hardware and/or software components, or through a combination thereof. Further, report generator 145 may reside as a standalone system within a network auction system 120 or may be a software component installed in an auction server 130. Report generator 145 may be configured to process requests from the provider browser 115 to query either the member database 135, auction database 140, or a combination of both. Data received from the query may be formatted by the report generator 145 and transmitted to the provider browser 115. As illustrated and discussed herein, the report generator processes report requests for the provider browser, however practitioners will appreciate that the report generator 145 may also be accessed by the account manager browser 170 and consumer browser 110 to facilitate providing reports to other parties.

The reports may include item information, bid information, conversion ratio information, and/or consumer information. Such information may include, for example, bids received, amount of bids received, distribution of bids received, identity of bidder, location of bidder, time of bid placement, date of bid placement, or service pricing. The reports may also facilitate the development of, or projections related to, service pricing, marketing plans, cash flow management, business capacity provisioning and resource provisioning.

Auction middleware 150 may include any hardware and/or software suitably configured to facilitate communications and/or process transactions between disparate computing systems. Middleware components are commercially available and known in the art. The auction middleware 150 may be implemented through commercially available hardware and/or software, through custom hardware and/or software components, or through a combination thereof. Auction middleware 150 may reside in a variety of configurations and may exist as a standalone system or may be a software component residing on the auction server 130. Auction middleware may be configured to process transactions between the auction server 130 and provider server 170 residing within a payment gateway 180.

Payment gateway 180 may include any hardware and/or software suitably configured to settle payments with provider 105. Payment gateway 180 may directly or indirectly interface with auction system 120. Payment gateway 180 may also include any known payment networks. Payments, as used herein, may include any partial or full payment with monetary or non-monetary form of payment such as, for example, loyalty points, cash, transaction account, transaction instruments, negotiable instruments, gift cards, rebates, securities, barter for goods or services and/or the like. In one embodiment, payment gateway 180 includes provider server 185 and firewall 190. Payment gateway 180 may include existing proprietary networks that presently accommodate transactions for credit cards, debit cards, and other types of financial/banking cards. Payment gateway 180 may be an open or closed network that is assumed to be secure from eavesdroppers. Exemplary transaction networks may include the American Express®, VisaNet® and the Veriphone® networks.

Provider server 170 may include any hardware and/or software suitably configured to facilitate management payments to provider. Provider server 170 may operate as a single entity in a single geographic location or as separate computing components located together or in separate geographic locations. Further, provider server 170 may be an Internet server or may send, receive and process data via a network both to and from a separate Internet server.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the present invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The present invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The computers discussed herein may provide a suitable web site or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The system may utilize an account number or loyalty number for access or to pay for the service. An “account” or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a fob having a transponder and RFID reader in RF communication with the fob. Indeed, system may include any device having a transponder which is configured to communicate with RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc. The account number may be distributed and stored in any form of plastic, electronic, magnetic, radio frequency, wireless, audio and/or optical device capable of transmitting or downloading data from itself to a second device.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

As discussed above, the invention includes a system and method for providing an auction, wherein consumers may use loyalty points to purchase items from providers, wherein the providers place winning bids on an opportunity to sell the items to the consumers. In another embodiment, consumers use loyalty points to place bids on items offered by providers, wherein winning bidders purchase the items from the providers with loyalty points. While various types of auctions exist and provide various methods for facilitating payment for items bid on and won during an auction, the invention disclosed herein enables consumers to redeem loyalty points in exchange for items offered for auction by a provider. The consumer is provided little or no information regarding the currency value of their points. However, this information is made known to the provider of an item put up for bid. In other words, the point-to-currency conversion ratio is known only by the loyalty point issuer and the provider of an item for bid. In another embodiment, the point-to-currency conversion ratio is known only by the loyalty point issuer, such that the consumer and provider are unaware of the currency value of the consumer's loyalty points. In various other embodiments, point-to-currency conversion ratios and/or point currency values may be known by or withheld from the consumer, the provider, a transaction account issuer, a host, a bank, an Automated Clearing House, and any combination thereof.

Practitioners will appreciate that auctions exist in various forms. Likewise, the disclosed system may employ any number and format of auctions. Such auctions include, for example, English auctions; Chinese auctions; Dutch auctions; sealed-bid, first-price auctions; sealed-bid, second-price auctions; all-pay auctions; and the like.

The disclosed auctions may include traditional auctions, online auctions, open auctions, closed auctions, auctions for charity, product auctions, service auctions, or any combination thereof. In one embodiment, a service based organization may offer services for specific date and time slots. For example, through analysis, an accounting firm may determine that the billable hours for its accountants are consistently low during the second week of each month. As such, the accounting firm may choose to participate in a calendar auction, wherein it may offer its accounting services at a discount during the second week of each month. Consumer 100 may search for desired services that are available during specific date and time slots, and apply a balance of loyalty points toward a bid for the offered services. For more information regarding a services based calendar auction, see U.S. patent application Ser. No. 10/710,068, filed on Jun. 16, 2004, which is hereby incorporated by reference.

Consumer 100 and provider 105 may interface with calendar system 120 by any means known in the art. Devices used to access the functionality disclosed herein may include, for example, a personal computer, cellular telephone, handheld device, household appliance, and the like. Interaction may take place by way of Internet, instant messaging, text messaging, email, telephony speech recognition, etc. In one embodiment, consumer 100 may select a scheduled auction that consumer 100 is interested in participating in. When the auction begins, consumer 100 may be alerted by text message, or any other method disclosed herein. Consumer 100 may view the highest bid, and place a bid by texting the bid amount using the keypad of a cellular phone, or like device. Auction system 120 recognizes the consumer 100 by way of caller ID, and enters the consumer's bid accordingly. For more information regarding mobile commerce, see U.S. patent application Ser. No. 11/741,077, filed on Apr. 27, 2007, which is hereby incorporated by reference.

In one embodiment, the auction is an online reverse auction, wherein providers bid on the opportunity to sell items to consumers. For example, a number of consumers may desire to purchase a laptop computer. A provider (merchant) who has a large inventory of laptop computers that he wishes to sell may place a bid based on the group of consumers wishing to purchase a laptop computer. When two or more providers compete to win the business of the consumers, the per-unit price is driven down. However, the disclosed auction may take any form, and is not limited to a reverse auction. Practitioners will appreciate, that while the invention is disclosed in various embodiments (e.g., reverse auction and English auction), the provider and the consumer may be used interchangeably. For example, when discussing the steps that a consumer needs to take to place a bid in accordance with an English auction, the invention anticipates that those, or similar, steps will apply to a provider in accordance with a reverse auction.

Loyalty points may be earned and redeemed in any number of ways. Moreover, other methods of providing an incentive may be used other than loyalty points in order to drive consumer spend. Issuing coupons based on a consumers spending history, for example, is one such method. Although an auction is disclosed herein in conjunction with the redemption of loyalty points, the invention is not so limiting. Other mediums having a monetary value or no monetary value may be used to place and/or accept bids within the disclosed online auction.

Loyalty points may be earned or issued based on the value of a purchase, a purchase quantity, a purchase location, participation in an event, and the like. Loyalty points may further be accumulated by an owner of a loyalty account based on such activities and/or by accepting a transfer of a balance of loyalty points from another loyalty account. Such transfer may be initiated by an owner of a first loyalty account for the benefit of the owner of a second loyalty account. Loyalty points may be transferred between a number of loyalty accounts owned by the same individual. Such a transfer may be a one-to-one point transfer, or may involve a point value and type conversion from a first value and type to a second value and type.

The loyalty points used to purchase items, as disclosed herein, may further be issued from related or unrelated entities based on a single purchase or any number of related purchases. For example, a consumer may use her American Express card to purchase a Sony television set from Best Buy. She may be issued three different sets of points based on the purchase by American Express, Sony, and Best Buy. Such multi-tiered rewards encourage spending based on the payment instrument, the manufacturer, and the merchant. For more information on various systems and method for issuing and redeeming loyalty points, rewards, and other incentives, see U.S. patent application Ser. Nos. 09/834,478; 09/836,213; 10/378,456; 10/708,580; 11/382,638; 11/548,203; and 11/551,778, each of which are hereby incorporated by reference.

The invention anticipates use with various other forms for facilitating financial transactions. Practitioners will appreciate that participation in the disclosed online auction may be facilitated through the use of rewards and points earned in conjunction with various other types of devices capable of facilitating financial transactions. Such devices may include, for example, smartcards, radio-frequency devices, biometric devices, and the like. For more information relating to alternative payment systems and methods, see U.S. patent application Ser. Nos. 09/754,465 and 10/710,307, each of which are hereby incorporated by reference.

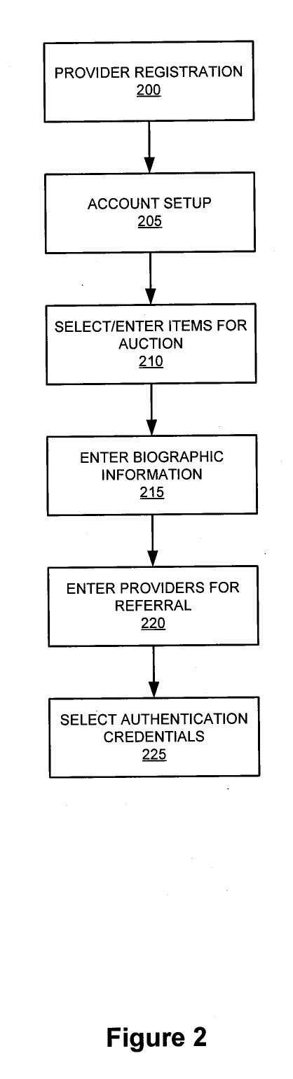

Referring to FIG. 2, to participate in the loyalty point based online auction, a provider 105 may initiate a registration process (step 200) through any methods known in the art. In one embodiment, provider 105 establishes a connection with auction system 120 and initiates the account setup process through web browser 110. The account setup process may include auction system 120 determining if provider 105 is a new user or a returning user which may be accomplished through any method known in the art, for example, by the use of cookies (tokens), or direct user input. For example, a provider 105 may be presented with a temporary account setup web page, which prompts provider 105 to input information concerning the provider's status as either a new or returning provider. An account manager 165 may define data that is required to be entered by provider 105 during the registration process. For example, auction system 120 may not allow provider 105 to continue with the registration process without entering basic company information such as company name, address, telephone number, email address, etc. However, the auction system may allow the registration process to continue if provider 105 does not complete a biography of provider's 105 items. In one embodiment, the system may also obtain provider or consumer information from available public databases or third party sources.

If it is determined that provider 105 is new to the auction system, as discussed above, provider 105 may be presented with an account setup web page (step 205) whereby the account setup process may be initiated. If provider 105 chooses to initiate the account setup process, they may be presented a web page containing terms for participating in the auction system. Further, provider 105 may be prompted to read the terms and provide input indicating whether or not provider 105 accepts the terms. If provider's 105 input indicates that the terms are not accepted, registration may not be continued and provider 105 may be again presented with an account setup web page. However, if provider's 105 input indicates that the terms are accepted, then provider 105 may be presented a web page for which to enter information such as, for example, company name, address, telephone number, name of a contact, email address, company web site, etc. When provider 105 completes and submits company and other information, the provider information may be transmitted to the auction system where it may be stored in member database 135.

Provider 105 may also be presented a web page and prompted to select from a list of items that provider 105 would like to offer for sale (step 210). For example, if provider 105 is a sporting goods store, he may indicate one or more specific items that he is capable of delivering, such as a tennis racket, a set of golf clubs, a mountain bike, etc.

In one embodiment, the auction system may be configured to automatically direct losing bidders and/or those placing bids below a reserve amount to items by the same provider 105 for similar items with a lower reserve. For example, the sporting goods merchant participating in an online auction may offer a professional grade mountain bike with a reserve of $650.00. A consumer 100 interested the mountain bike who places a bid at $480.00 may be directed to another auction of an advanced grade mountain bike offered by the same sporting goods merchant, but with a reserve set at $450.00. The system or any participant may also distribute or redeem loyalty points at any point of the disclosed online auction process. For example, a referral recipient may send provider loyalty points in exchange for sending the referral. In another embodiment, the system may award loyalty points to consumers based on a number of bids placed during a predetermined time period.

Auction system 120 may additionally or alternatively allow provider 105 to enter information related to their items for sale, or auction system 120 may acquire item information from provider 105 web site or other database. The item offerings information may be transmitted to auction system 120 where it may be stored in member database 135.

Providers 105 are presented a web page to enter biographic information (step 215) which may include, for example, a short history of provider's 105 company, a description of the management team, client list, stock symbol, balance sheet data, credit rating, etc. The biographic information is transmitted to auction system 120 where it is stored in member database 135.

Providers 105 are presented a web page where they may list one or more providers (step 230) that offer similar items to their own in order to serve as referrals if, for any reason, provider 105 cannot provide a desired item to a participating consumer. There are a number of scenarios where this may be beneficial to both provider 105 and consumer 100. For example, if consumer 100 places a bid that falls short of a reserve amount, it may be clear that the consumer 100 cannot, or is not willing to pay the provider's bottom rate. The consumer 100 may be presented with one or more provider 105 referrals which may be able to offer a similar item at a lower cost. If a referred provider is a participant in the auction, consumer 100 may be directed to view active and/or scheduled auctions for that provider 105.

If a referred provider is not an auction participant, then they may be alerted to a consumer's interest in their items via email or any other means of notification. Alternatively, a link to a referrals web site may be provided in order to allow a consumer 100 to obtain information regarding the referral and/or contact information. Auction system 120 may employ a means to identify a consumer 100 who selects a link to a referral's web site. This information may be collected and used for market analysis, crediting a provider 105 who made the referral or for any other purpose. Practitioners will appreciate that there are a number of methods known in the art for collecting information regarding “click-throughs” in an Internet environment, including the use of cookies and URL tags. When a consumer 100 purchases an item from a referred provider 105, either by placing a winning bid or by utilizing a “buy it now” option, then referring provider 105 may receive compensation, or a “finder's fee”.

Provider 105 is presented a web page where provider 105 is prompted to choose authentication credentials (step 225) to be used by auction system 120 to verify the provider's identification prior to participation in auction system 120. Provider 105 may submit selected authentication credentials to auction system to be verified. If the authentication credentials are not verified, provider 105 may again be presented a web page where provider 105 may select different authentication credentials. When authentication credentials are valid, then provider 105 is presented a provider home web page.

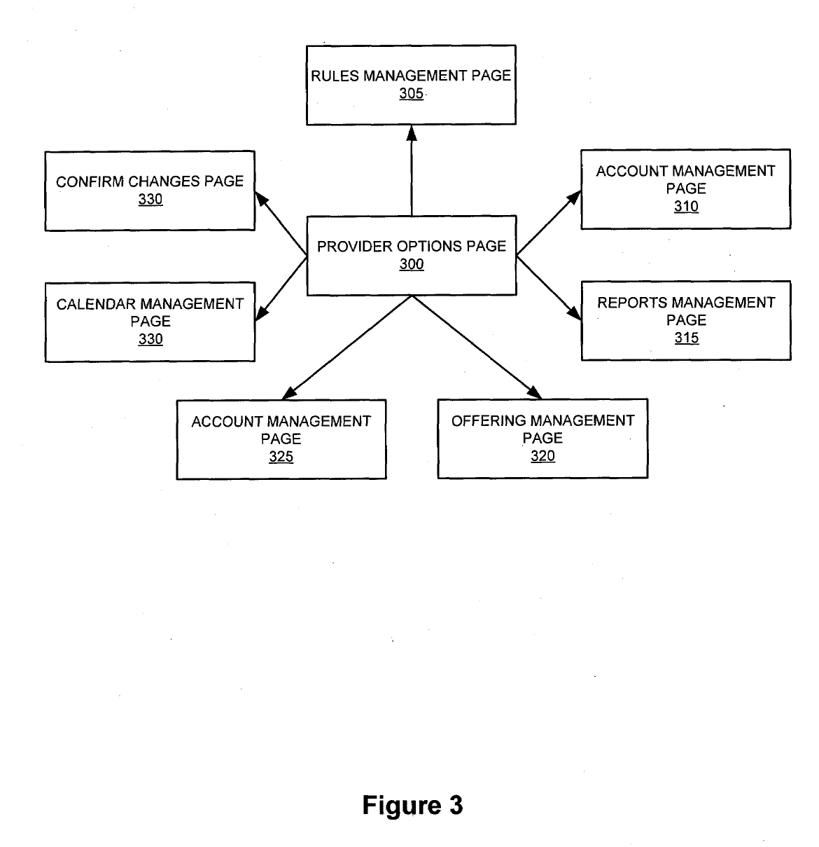

With reference to FIG. 3, the provider homepage presents provider 105 with various auction related information. For example, in various embodiments, provider homepage may present provider 105 with industry news and/or general auction statistics relating to the industry of provider 105. In an exemplary embodiment, auction system 120 provides a central location where provider 105 may manage several aspects of the auction account. To initiate auction account management functions, provider 105 accesses the provider homepage. When provider 105 chooses to view and/or modify provider options, provider 105 may be prompted to enter authentication credentials. When properly authenticated, provider 105 is granted access to a provider options web page 300. A provider 105 who is not properly authenticated, either through user error or because of unauthorized use, is not permitted further access to provider options and may be again prompted to enter authentication credentials. Practitioners will appreciate that many additional security measures may be employed in accordance with the authentication processes described herein.

The provider options web page 300 includes links directed toward other web pages for managing various aspects of the auction account. Auction options which may be configured by provider 105 may include, for example, rules management, account management, and reports management, each being described in greater detail below.

The rules management web page 305 may be accessed by provider 105 to configure rules specific to an auction. Such rules may be defined by provider 105 in advance of an auction in order to more closely control the nature of the auction. Such rules may include, for example, setting durations for auctions, setting reserve amounts for one or more items, conditions for providing referrals, defining consumer 100 criteria requirements for participating in provider's 105 auctions and setting a price for one or more items for which provider 105 may accept should a consumer decide to purchase an item and bypass the bidding process. The rules management process will be described in greater detail herein.

The account management web page 310 may be accessed by provider 105 to add and/or modify company specific information as submitted during the registration process. Specifically, provider 105 may add and/or modify company and contact information as entered. Such information may include company name, contact name, street address, telephone number, email address, web site address, and the like. Account management may also be used to add and/or modify the provider's items, item descriptions, and biographical information as entered.

The reports management web page 315 may be accessed by provider 105 to view reports based on auction history. In an exemplary embodiment, the auction system 120 may provide standard and/or custom reports which may equip provider 105 with an analysis tool for determining and/or executing strategic decisions. For example, a sporting goods merchant that regularly participates in auctions may choose to view a report showing details for all winning bids. From her analysis of the report information, the sporting goods merchant may determine that the volume of bids as well as the high bid amount for golf clubs is significantly higher during the months falling between March and June. With this information, sporting goods merchant may choose to auction more golf related items during the months of April and May.

Reports generated from a reports management web page 315 may also show a provider 105 what types of consumers 100 are bidding for their items and/or related providers items. Demographic data such as, for example, consumer 100 information, bid amounts, trends in bidding activity and the like, may be a valuable tool to assist provider 105 in developing a marketing and pricing strategy. For example, a provider who has set a “buy it now” price at $180 for a tennis racket may discover that winning bids for comparable tennis rackets from other providers are averaging $160. This information combined with other report data may make it clear that the provider is over-pricing his items. Further, a report may provide a listing of all consumers 100 who have participated in an auction for a particular item type. This may be utilized by a provider 105 for business development and marketing tasks.

While not illustrated herein, a practitioner will appreciate that various tools and methods may be employed to compile, display, print and store reports as described above and within the context of the disclosed auction system. Further, it will be appreciated reports management may be carried out through a number commercially available report generators, through custom software and/or hardware components, or through a combination thereof. Still further, it should be appreciated that reports may be generated from any combination of data stored on any combination of databases, files, stored procedures and the like.

When provider 105 with an auction account accesses auction system 120, provider 105 may configure rules pertaining to an auction of provider's 105 items. Rules may be configured to apply universally to all of provider's 105 service auctions. However, as discussed herein, rules may be configured for each item individually, if desired. For example, provider 105 offering two distinct items; Item A and Item B, may choose to set the reserve amount for Item A to $85.00 while setting the reserve for Item B to $110.00. To configure auction rules, provider 105 may access a rules management web page following authentication as described above. From a rules management web page, provider 105 may choose to view an item as previously defined and stored within auction system 120. From an offerings web page 320, provider 105 may be prompted to select an item to view and is then prompted to select a specific rule to configure with regard to the selected item.

When the provider's input from the select service offering web page indicates a desire to define and/or modify a reserve, then provider 105 is presented a web page from which a reserve may be defined and/or modified. As in any of the management functions, auction server 130 is queried to obtain any previous values in order to allow provider to view previously defined rules. For example, provider 105 may have previously set a reserve amount for Item A to $90.00. When provider 105 accesses the define/modify reserve web page, the web page may display the previously set reserve amount ($90.00). If a reserve had not been previously set, the reserve amount may be displayed as $0.00. Provider 105 may change the reserve amount by entering a new reserve amount within a define/modify reserve web page and submitting the information to auction system 120 to be stored within member database 135.

When the provider's input from the select offering web page indicates a desire to define and/or modify a base purchase price, then provider 105 is presented a web page from which a base purchase price may be defined and/or modified. A base purchase price may be any amount that provider 105 determines acceptable, should a consumer 100 during an auction choose to bypass the bidding process and purchase the service (“buy it now”). Participation in a auction with a base purchase price may be optional; therefore, provider 105 is prompted to indicate whether or not to implement a base purchase price. A provider 105 who wishes to set a base purchase price, may enter a desired amount in a web page field and submit the information to the auction system to be stored within member database 135.

When the provider's input from the select offering web page indicates a desire to define and/or modify consumer criteria, then provider 105 is presented a web page from which consumer criteria may be defined and/or modified. Consumer criteria enables provider 105 to define who may or may not place bids on provider's 105 items during auction. For example, a provider 105 may choose to limit bid participation to consumers 100 with a certain brand of loyalty points. Criteria used to define acceptable consumers 100 may not be limited only to information required by a consumer 100 during the consumer registration process. For example, auction server 120 may initiate contact with any third party system such as one or more credit bureaus in order to obtain consumer's 100 credit rating and then store credit information within member database 140. Defined and/or modified consumer criteria are submitted to the auction server where it is stored within member database 135.

When the provider's input from the select offering web page indicates a desire to define and/or modify auction duration, then provider 105 is presented a web page from which auction duration may be defined and/or modified. In an embodiment, duration may be defined in time. For example, a provider 105 may choose set an auction for item A to last for 48 hours. When the 48 hours expires, the auction would close and the highest bidder, if applicable, would be awarded the auction item. In another embodiment, provider 105 may choose to end an auction upon receiving a predetermined number of bids. In yet another embodiment, provider 105 may choose to end an auction when a bid of a determined amount has been obtained. Additions and/or changes to auction duration defined by a provider 105 are submitted to the auction server and stored within member database 135.

When the provider's input from the select offering web page indicates a desire to define and/or modify referrals, then provider 105 is presented a web page from which referrals may be defined and/or modified. At any time, a provider 105 may opt-in or opt-out of a referral program as well as add, modify, or delete referrals. Referrals may be participants in auction system 120, however this is not necessary. Participating providers 105 may be listed within a define and/or modify referral web page, from which provider 105 may select one or more to serve as their referral(s). If a referral is not a participant in auction system 120, then a define and/or modify referral web page may offer text fields where provider 105 may enter information such as name of provider, address, telephone, email address, web site address, contact name, relationship with provider, types of services offered, etc.

In an embodiment, provider 105 may additionally view other referral program details such as, for example, a rewards or finder-fee account balance, transactions which have occurred based on the provider's referral, and the like. Alternatively, this information may be included and accessible from the reports management web page. Additions and/or changes to provider's 105 referrals defined by a provider 105 may be submitted to auction system 120 and stored within member database 135.

Practitioners will appreciate that changes in auction rules as described above, may not effect auctions in progress, but would be applicable to any scheduled auctions which have not yet opened to accept bids. However, in another embodiment, the system may allow rules and settings to apply at the time they are changed.

When provider 105 with an auction account accesses auction system 120, provider 105 may add and/or modify auction account information originally entered during the registration process. For example, a provider who wishes to change the main contact name, may initiate the modification from an account management web page. It should be appreciated that provider 105 may be prevented from modifying certain types of account data because certain data modifications may be a function of an account manager 165.

To define or modify account details, provider 105 may access the account management web page 325 following authentication as described above. From an account management web page, provider 105 may choose to view account details as previously defined by provider 105 and stored in member database 135. From an account details web page, provider 105 is prompted to select a class of account information to modify. According to an embodiment, account information may be grouped within three classes; contact data, company biography, and service offerings and descriptions. It should be appreciated that the classes as illustrated and described herein have been grouped for simplicity only. Practitioners will appreciate that the account information as described herein is not intended to be exhaustive and may be arranged within any number of classes.

When the provider's input from the select details web page indicates a desire to add or modify company and/or contact data, provider 105 may be presented a web page displaying company and/or contact data as it exists within auction system 120. Provider 105 may modify the information within the web page and submit the information along with any changes to the auction server where it is stored within member database 135.

When the provider's input from the select details web page indicates a desire to add and/or modify biographic information, the provider 105 is presented a web page displaying biographic data as it exists within auction system 120. Provider 105 may modify the biographic information within the web page and submit the information with any changes to auction system 120 where it is stored within member database 135.

When the provider's input from the select details web page indicates a desire to add and/or modify items and descriptions, provider 105 may be presented a web page displaying items as they exist within auction system 120. In an embodiment, provider 105 may offer varying types and/or categories of items, therefore, auction system 120 allows for one or more items to be defined and managed. Provider 105 may use a web page to modify items and/or define additional items at any time. Provider 105 may add and/or modify items information within a web page and submit the information along with any changes to auction system 120 where it is stored within member database 135.

When the provider's input from the select details web page indicates a desire to close provider's 105 auction account, provider 105 is presented a web page to confirm provider's 105 intentions to no longer participate in the auction system. In an embodiment of the invention, the close account web page may request additional information from provider 105 such as, for example, information to ascertain why provider 105 is closing the auction account. When provider 105 submits the close account information to auction system 120, data pertaining to provider 105 may be flagged or eliminated from any databases residing within auction system 120.

When provider 105 with an auction account accesses auction system 120, provider 105 may setup and maintain a calendar in order to facilitate auctions. In an embodiment of the invention, the calendar serves as the mechanism by which auctions for a provider's 105 items are scheduled. To manage a calendar, provider 105 accesses a calendar management web page 330 following authentication as described above. The calendar management web page includes snapshot information relevant to a provider 105 such as, for example, the status of in progress auctions, listed dates for upcoming auctions, warnings regarding scheduling conflicts, and the like.

In one embodiment, provider 105 may maintain two or more separate calendars. The calendar management web page 330 includes a selector from which provider 105 may indicate which auction account calendar to view and/or modify. For example, provider 105 may be an owner of two or more business entities which fall under a parent company. Rather than create entirely different auction accounts for each company, it may be advantageous to allow provider 105 to manage auctions for each entity within one primary account.

When provider 105 selects a calendar to manage from a calendar management web page 330, provider 105 is presented a web page displaying the selected calendar populated with data from auction system 120. As discussed previously, a calendar may be displayed in any number of configurations. It should be noted however, that an embodiment of the invention allows provider 105 to define a preferred calendar view. For example, one provider 105 may prefer to view a calendar in weekly increments, while another provider 105 may prefer to view a calendar in increments of one month. While yet another provider 105, may prefer a calendar that displays all twelve months.

Aside from specific calendar configurations, sequences of time where provider 105 has scheduled auctions are displayed in a manner as to communicate times of auction activity. For example, provider's 105 calendar may reflect future auction dates by employing a method of color coding, by which scheduled auction days would stand out from days of non-activity. The same may apply to auctions which are in progress. Other configuration are contemplated, such as displaying auction details on a calendar, for example, auction name, item, start time(s), end time(s), current high bid(s) for auctions in progress, etc.

In another embodiment, a calendar allows provider 105 to view demand for various items. Consumer 100 may use a calendar, as will be discussed below, to express interest in a service or services during certain date/timeslots. The provider's 105 calendar may reflect the demand of any number of consumers, thereby allowing provider 105 to tailor service items and schedule auctions to best fit consumer demand as indicated on provider's 105 auction calendar. The system may automatically match openings in provider 105 and consumer 100 calendars and suggest possible availabilities.

From the auction calendar, provider 105 may select a date and/or timeslot to view in greater detail. Date/timeslot detail presents provider 105 a precise view of a selected date and/or timeslot. This view may include details regarding scheduled or in progress auctions such as, for example, description of items for auction, auction start time, end time, current high bid and the like. A date/timeslot view of a calendar provides options to allow provider 105 to schedule auctions, modify scheduled auctions and/or cancel scheduled auctions.

If provider 105 wishes to cancel a prescheduled auction, provider 105 may select the scheduled auctions date/timeslot and select the scheduled auction from the show date/timeslot web page. Provider 105 may then indicate that the scheduled auction should be canceled. Provider 105 may then be prompted or presented with a conformation web page from which provider is asked to confirm the cancellation. When provider 105 confirms the cancellation, then provider 105 may again be presented with a show calendar web page and the cancellation is transmitted to the auction system 120 where the information relating to the scheduled auction is removed from an auction database 140. If provider 105 does not confirm the cancellation, then provider 105 is again presented with a select date/timeslot web page and the auction remains scheduled.

When the provider's input from the date/timeslot view web page indicates a desire to schedule an auction or modify a previously scheduled auction, provider 105 is presented a web page and prompted to select an item to offer for auction. Items may be displayed based on the items previously defined either during the registration phase or during the account management phase. Items are displayed on a service offerings web page as a list, a menu, group of check boxes, or by any other method known in the art. If provider 105 selects an item from the select service offering web page, then provider 105 is presented a web page or prompted to enter a duration for the auction. Provider 105 may choose to not change the displayed duration, which would be the default duration configured during the rules management process. However, provider 105 may choose to enter a new auction duration, which would apply only to the auction being scheduled or modified.

In one embodiment, provider 105 is prompted on whether or not the scheduled auction should be a reoccurring auction. In other words, provider 105 may desire to instruct auction system 120 to schedule the same auction repetitively over defined sequences. For example, a provider of gardening supplies may choose to offer potted flowers every May over the course of three years. If provider 105 selects to schedule an auction on a reoccurring basis, provider 105 is presented with a web page to define the reoccurrence schedule and duration.

Finally, provider 105 is presented a confirmation web page 335 which provides a summary of the auction as defined it in the proceeding steps. Provider 105 is prompted to accept or cancel the pending auction. If provider 105 cancels the pending scheduled auction, provider 105 may again be presented with the select date/timeslot web page where scheduling data may be re-entered. In this case, the schedule data is not be transmitted and stored on auction system 120. If provider 105 accepts a pending scheduled auction, then the scheduled auction is transmitted to the auction system and stored in auction database 140.

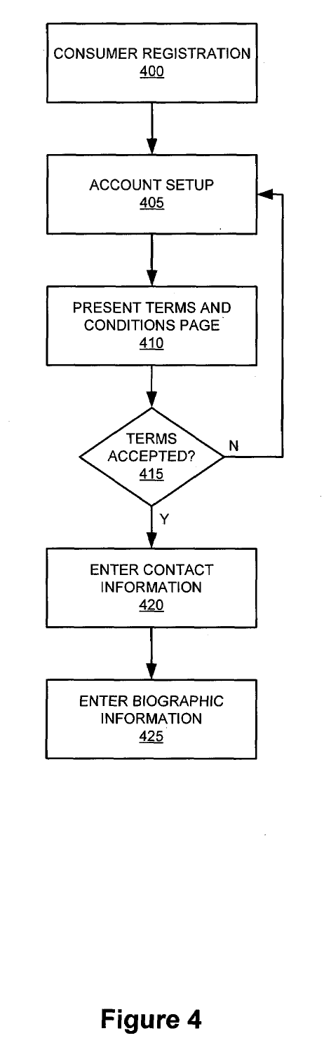

With reference to FIG. 4, consumer 100 may initiate a registration process (step 400) through any methods known in the art. In one embodiment, consumer 100 accesses auction system 120 and initiates the account setup process through a web browser 110. The account setup process may include determining if a consumer is a new user or a returning user through any method known in the art, for example, by the use of cookies, or direct user input. For example, a consumer may be presented with a temporary account setup web page, which prompts the consumer 100 to input information concerning the consumer's status as being either a new or returning user.

According to an embodiment, account manager 165 may define data which is required to be entered by consumer 100 during the registration process. For example, an auction system 120 may not allow a consumer 100 to continue with the registration process without entering basic consumer information such as consumer name, address, telephone number, email address, etc.

When it is determined that consumer 100 is new to auction system 120, as discussed above, consumer 100 may be presented with an account setup web page (step 405), whereby the account setup process may be initiated. If consumer 100 chooses to initiate the account setup process, consumer 100 is presented a web page containing terms (step 410) for participating in auction system 120. Further, consumer 100 may be prompted to read the terms and provide input indicating whether or not consumer 100 accepts the terms. If consumer's 100 input indicates that the terms are not accepted (step 415), the registration process does continue and consumer 100 may be again presented with an account setup web page (step 405). However, if consumer's 100 input indicates that the terms are accepted (step 415), then consumer 100 is presented a web page for which to enter consumer and contact information (step 420). Such information may include, for example, name, address, telephone number, name of a contact, email address, web site, etc. When consumer 100 completes and submits consumer and contact information, it is transmitted to auction system 120 where it is added to member database 135.

Consumer 100 may then be presented a web page to enter biographic information (step 425) which may include, for example, a short history of consumer 100 company, a description of the management team, client list, stock symbol, balance sheet data, credit rating, etc. Upon submitting biographic information (step 720), it may be transmitted to the auction system (step 745) where it may be committed to a member database 135.

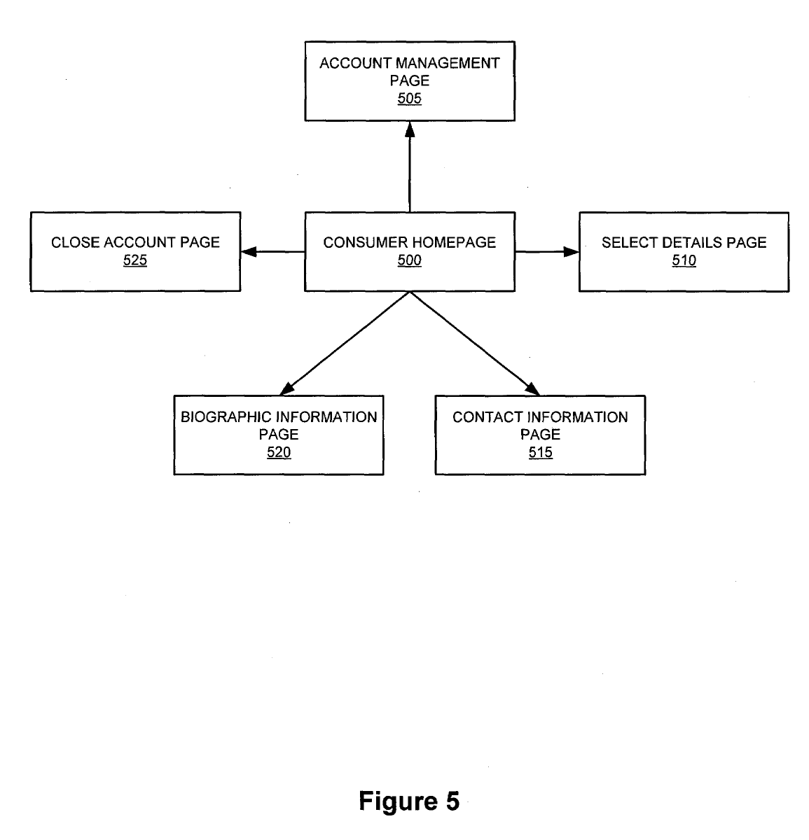

In an exemplary embodiment, a management process provides for a central location where consumer 100 may manage aspects of an auction account. With reference to FIG. 5, consumer 100 may access a consumer homepage 500. When consumer 100 chooses to view and/or modify consumer options, consumer 100 is prompted to enter authentication credentials. Authentication credentials are transmitted to auction system 120 to be authenticated. When consumer 100 is properly authenticated, access is granted to a consumer options web page. Practitioners will appreciate that many additional security measures may be employed in accordance with the authentication processes disclosed herein. The consumer options web page includes links directed toward managing various aspects of consumer's 100 auction account.

An account management web page 505 may be accessed by consumer 100 to add and/or modify consumer specific information as submitted during the registration steps. Specifically, consumer 100 may add and/or modify consumer, company and contact information as entered. Such information may include, for example, consumer name, company name, contact name, street address, telephone number, email address, web site, and the like. Account management may also be used to add and/or modify the consumer's biographical information as entered.

In order to define and/or modify account details, consumer 100 is provided access to the account management web page 505 following authentication as described above. From the account management web page, consumer 100 may choose to view account details as previously defined by consumer and stored in the auction system. From the select details web page 510, consumer 100 may be prompted to select a class of account information to modify. According to one embodiment, a consumer's account information can be grouped within two classes; company and contact information and biographical information. It should be appreciated that the classes as illustrated and described herein have been grouped for simplicity. Practitioners will appreciate that the account information as described herein is not intended to be exhaustive and may be arranged within any number of classes.

When consumer's 100 input from the select details web page 510 indicates a desire to add and/or modify company and/or contact information, consumer 100 may is presented a web page displaying company and/or contact information 515 as it exits within an auction server. Consumer 100 may modify the information within the web page and submit the information along with any changes to the auction system to be stored within a member database 135.

When consumer's 100 input from the select details web page 510 indicates a desire to add and/or modify biographic information, consumer 100 may be presented a web page displaying biographic information 520 as it exists within the auction server. Consumer 100 may modify the biographic data within the web page and submit the information along with any changes to the auction system 120 to be stored within a member database 135.

When consumer's input from the select details web page indicates a desire to close consumer's 100 auction account, consumer 100 may be presented with a web page to confirm consumer's 100 intention to no longer participate in auction system 120. In an embodiment, the close account web page 525 may request additional information from a consumer 100 such as, for example, information to ascertain why consumer 100 is closing an auction account. When consumer 100 submits close account information to auction server 130, information pertaining to consumer 100 may be eliminated from the auction system databases.

In one embodiment, a consumer may elect to receive notifications regarding upcoming auctions which may fall within consumer 100 defined interests or any other announcements, solicitations, newsletters, and the like. Further, information regarding consumer's 100 bidding habits, item needs, company information, and the like, may be distributed to providers 105 either in the form of reports, as discussed above, or any other distribution system and/or method. Auction system 120 may provide preferences during account setup and/or account maintenance for consumer 100 to opt-in or opt-out for notifications and/or the distribution of consumer's 100 data.

Consumer 100 may participate in an auction by navigating to the auction web site and selecting a link to a consumer homepage. If consumer 100 is not logged in to auction system 120, then consumer 100 may be prompted to enter authentication credentials. Once the user ID and/or password is entered, it may be transmitted to the auction system to be authenticated. If consumer 100 is properly authenticated, then consumer 100 is granted access to a consumer homepage.

Consumer 100 may select a link on the consumer homepage to view current and/or scheduled auctions. In one embodiment, a “view auctions” web page may contain detailed information for each auction listed. However, practitioners will appreciate that there are a number of ways for viewing information specific to a selected auction including, for example, a separate web page or a popup window. Information regarding an auction may include an item description, provider's name, provider's biography, a link to provider's web site, auction start time, auction end time, reserve amount, winning bid, number of bidders, and the like.

In one embodiment, consumer 100 may link any number of loyalty accounts to the consumer's auction account. Accordingly, auction system 120 is quickly able to determine loyalty account balances and the type of loyalty account. For example, a consumer may have an American Express loyalty account with a balance of 25,000 points. The auction system may determine that each point in the account has a point-to-currency ratio of 50 to 1. Therefore, a provider of air transportation may choose to put a 25,000 point reserve on an auction of a flight that is worth $500. As will be explained in greater detail, the disclosed auction system reveals little or no information relating to the point-to-currency ratio to participating consumers.

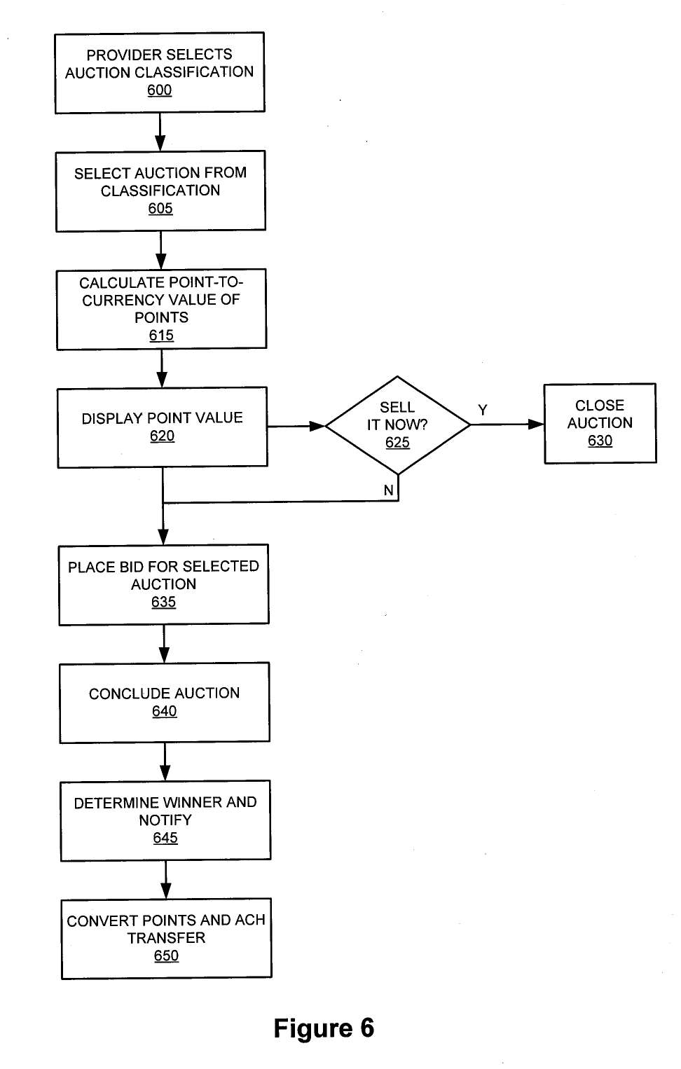

Referring to FIG. 6, according to a reverse auction embodiment, provider 105 accesses auction system 120 by way of a web browser, and searches for and/or selects classifications for auctions that provider 105 would like to view (step 600). Auctions may be classified by item type, consumer type, number of participating consumers, types of loyalty points held by the consumers, and the like. When provider locates an auction to participate in (step 605), auction system 120 determines the loyalty point types of the various consumers within an auction group, calculates a point-to-currency value for the points based on the point types, and provides provider with a conversion ratio and point values (step 610). In one embodiment, the consumer may provide to auction system 120, a particular amount or type of points that the consumer is willing to submit. In another embodiment, auction system 120 obtains from certain consumers or consumer accounts, a subset of points or types of points, obtains points based on certain rules, algorithms, or random, based on points obtained from consumers in the past, based on points obtained from other consumers, based on estimated value of the auctioned item and/or the like.

Based on this information, provider 105 may choose to place a bid for the opportunity to sell items to the auction group (step 635). The provider places a bid by, for example, entering a number of loyalty points that provider 105 will accept in exchange for the provider's items. If any other bids have been previously placed, the bid is not accepted by auction system 120 if the bid amount is not lower than the previously submitted bids. In another embodiment, provider 105 may alternatively choose to accept a baseline purchase price defined by the consumers, and thus bypass the bidding process, by selecting a “sell it now” link (step 625), thereby concluding the auction (step 630).

In one embodiment, consumers may be grouped by auction system 120, according to loyalty account type. For example, a group of 38 consumers may desire to purchase a flat-screen television. Ten of the consumers may have a Visa loyalty account, eighteen may have an American Express loyalty account, and the remaining ten may have a MasterCard loyalty account. Because each of the loyalty accounts may issue points under different currency-to-point ratios, auction system 120 will need to calculate the monetary value of the points differently. As such, the auction system may create three sub-groups, each representing the different loyalty account type.

When the duration of an auction has expired (step 640), auction system 120 determines the winning bid (lowest bid) and alerts the winning provider 105 and the consumers that the winning bid was placed on (step 645). In one embodiment, auction system 120 verifies the provider's ability to supply an adequate number of items based on the demand from the consumers prior to opening the auction for bidding. In another embodiment, auction system confirms the provider's ability to supply an adequate number of items based on the demand from the consumers after the auction ends, but prior to settlement.

During settlement, auction system issues a request to the loyalty account issuer of the winning consumers. The request identifies the loyalty accounts of the winning consumers and the amount of loyalty points corresponding to the currency value of the winning bid. The account issuer converts the loyalty points to the currency value, and a transfer in the name of the winning provider is facilitated through an Automated Clearing House (ACH) (step 650). Practitioners will appreciate that any method of transferring currency from a first account to a second account may be implemented without affecting the scope of the invention.

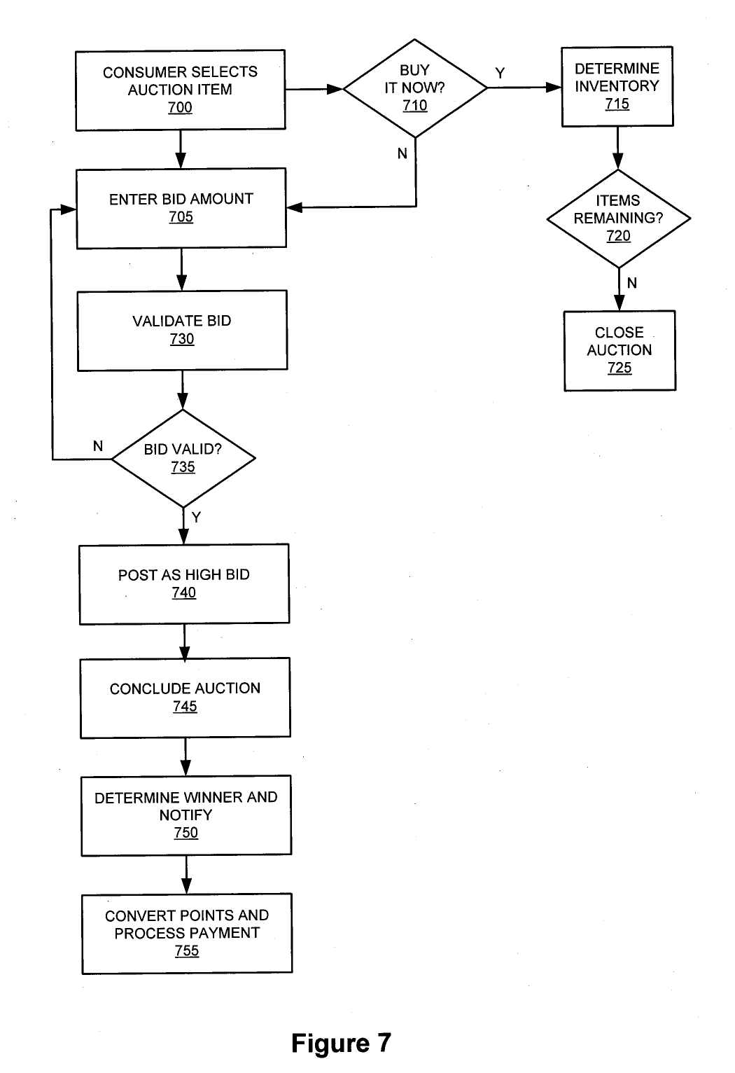

Referring to FIG. 7, according to a standard English auction embodiment, consumer 100 places a bid on an auction item (step 700), by selecting an auction item for which to enter a bid (step 705). Consumer 100 may have an options of purchasing the service outright (if provider 105 chose to offer a purchase option for the selected item), or entering a bid amount in excess of the current high bid. Consumer 100 may choose to purchase the item, and thus bypass the bidding process, by selecting a “buy it now” link (step 710). If consumer 100 chooses to bypass the bidding process and no additional inventory remains (step 720), then the auction is closed and no further bids are accepted (step 725). However, if consumer 100 chooses to place a bid on the item, consumer 100 is prompted to enter a bid amount (step 705). When a bid amount is entered and submitted, the bid amount is transmitted to the auction system where it is validated against a previous high bid and a reserve amount, if any (step 730). If a bid amount does not meet both criteria, the bid amount is not valid and consumer 100 is notified of the deficiency and prompted to enter a bid that is inline with the criteria (step 705). If consumer's 100 bid amount is determined to be a valid, the bid amount is posted to the auction server where it is stored in an auction database 140 as a new high bid for the item (step 740).

In one embodiment, auction system 120 displays the winning bid amount, such that other consumers may determine whether to participate, and if so, how many loyalty points to apply toward a bid. The winning bid is shown as a number of loyalty points. For example, a consumer may consider bidding on roundtrip airfare to Orlando, Fla. The consumer will immediately see that the current winning bid is 32,000 American Express reward points. However, the provider of the airfare will be able to see the winning bid as a currency amount. The currency amount is calculated by auction system 120 by determining the point-to-currency conversion ratio and multiplying it by the number of points bid.

Auction system 120 may require consumer 100 to previously establish and identify one or more loyalty accounts with the system to ensure the availability of loyalty points prior to allowing consumer 100 to participate in any auction. As such, auction system 120 also confirms that consumer 100 has a sufficient balance of loyalty points to support a submitted bid amount. In one embodiment, auction system 120 holds a certain balance of a loyalty account during the auction process, and then releases the balance if the consumer does not place the winning bid.

When an auction duration has expired, as previously defined by a provider 105, the auction is closed (step 745). Auction system 120 determines which participating consumer 100, if any, won the auctioned item (step 750). If a winning bid is validated, the results are posted to the auction web site and information required by a payment gateway regarding provider 105, consumer 100, and bid amount are transmitted to the payment gateway for processing (step 755). Practitioners will appreciate that there exists a number of payment systems which are known in the art.

Following the posting of auction results and transmittal of payment details to a payment gateway, notification is sent to both consumer 100 with the winning bid, and to provider 105 of the auctioned item. Auction system 120 may also notify consumer 100, provider 105, account manager 165 and/or any other third party (via any communication device discussed herein or known in the art) regarding any data, results, or actions during any phase of an auction. For example, auction system 120 may notify provider 105 when each bid is received or when a bid above a certain amount is received.

According to one embodiment, auction system 120 enables a consumer 100 holding a winning bid to sell the winning bid to another interested and willing consumer 100. This functionality may be employed by any number of methods; however it is contemplated that a consumer 100 with a winning bid may have a system and/or method to indicate that they are willing to receive offers on the winning bid. Further, consumer 100 may set a price they are willing to accept for the bid. Another consumer 100 interested in purchasing the bid, may indicate a willingness to do so either through functionality built into the auction system, or contact information may be provided for person-to-person negotiation. Auction system 120 may further allow a consumer 100 who has purchased an item through a “buy it now” step, to sell the rights to the purchased item.

Various other embodiments of the invention provide features that add to the auction's functionality, utility, and appeal. With respect to content, which may be made available for auction participants, auction system 120 may provide a means for provider 105 and/or consumer 100 to upload files to be stored in auction system 120 database and may include, for example, photos, graphics, .PDF files, sound files and the like. These files may comprise product photos, company logos, photos relating to services, white papers, press releases, news articles, recorded statements, etc.

According to one embodiment, auction system 120 provides views of upcoming auctions, past auctions (including auction descriptions, winning bid details, etc.), a winning bid photo gallery, and the like. Additionally, consumer 100 and provider 105 may control web page views, appearance, layout, etc. For example, auction system 120 may provide controls, which are used by an auction site user to apply a color scheme to the auction web pages according to the user's preference.

Auction system 120 provides a bid history page where consumer 100 and/or provider 105 may view a bid history for a selected auction. Bid history may include, for example, the identities of top bidders, bid values, date and time bids were submitted and the like. A bid history may provide a view of bids relating only to auctions a consumer 100 or provider 105 has participated in, or for all auctions occurring over a period of time. In addition, a bid history view may be configured by a consumer 100 and/or provider 105 according to their preferences.

Auction system 120 allows consumer 100 to rate provider 105 based on past experience with the provider 105. A rating system may be open to all registered and/or unregistered consumers 100 or may be limited to those who have placed a winning bid on a prior auction for the provider's items. A rating system may also include a system and/or method for a provider 105 to rate consumers 100. This may be useful in determining which consumers 100 bids a provider may choose to accept or decline in current and/or future auctions.

In one embodiment, auction system 120 visually groups auctions according to predefined categories such as, for example, travel services, sporting goods, building supplies, home decorating, clothing, and the like. Auction groupings may also include indicators to show how many auctions are in progress or scheduled within each category. Alternatively, auctions may be grouped according to a user's preferences.

Auction system 120 enables a user to search an auction system 120 for auctions based on one or more search keywords. Additionally, a consumer 100 may search for a provider 105 by inputting a nickname or a number which may be uniquely associated a particular provider 105. Practitioners will appreciate that there are a number of methods for facilitating and executing a search within an Internet environment which may be implemented within an auction system 120.

Auction system 120 may provide users with a system and/or method to obtain online help. Online help may be implemented through one or more frequently asked questions web pages where a user may view answers to commonly asked questions. Online help may also include an online form where a user may enter problems, questions, suggestions, etc. and submit the entry to an auction server 120. Answers and/or responses based on a user's submission may be delivered to a user by any means known in the art including email, a web page, telephone response, postal mail, etc. Auction system 120 may also employ live help to assist users in real-time. Live help may provide a means for a user to submit specific questions, problems and/or concerns to a live customer support representative and receive a response in real-time. Live help may be facilitated through a chat-like environment similar to those offered my MSN Messenger and Yahoo! Messenger. Live help may also employ computing logic to decipher information submitted by a user and respond based on a pre-defined response which may be stored within an auction system 120.

Additionally, auction system 120 may notify a consumer 100 of upcoming auctions which might be of interest. Notification may be delivered via any method known in the art such as, for example, email, text message to a cell phone or pager, recorded message over a telephone, etc. Auction system 120 may provide a system and/or method for consumer 100 to define criteria indicating interest in certain types of auctions. Additionally, auction system 120 may use consumer's 100 prior bid histories to determine which auctions consumer 100 may be interested in.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “includes”, “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

We claim:

1. A method for facilitating a point based auction between a consumer and a provider, said method including:
receiving, from said provider, an item, wherein said item is at least one of: a product and a service;
determining a currency value of a subset of a point balance belonging to said consumer;
communicating said currency value to said provider;
receiving a bid from said provider based on said currency value;
determining when said bid is an optimal bid for said item;
deducting said subset of said point balance from an account of said consumer when said bid is an optimal bid, wherein said currency value is unknown to said consumer;
converting said number of loyalty points to said currency value; and,
crediting said currency value to an account of said provider.

2. The method of claim 1, wherein receiving a bid comprises receiving at least one of currency value and an amount of points.

3. The method of claim 1, further comprising receiving, from said consumer, a purchase indicator, wherein said purchase indicator is indicative of a desire to purchase said item.

4. The method of claim 1, further comprising receiving, from said consumer, a purchase indicator, wherein said purchase indicator is indicative of a desire to purchase said item using said subset of said point balance.

5. The method of claim 1, wherein said purchase indicator includes a reserve.

6. The method of claim 1, further including notifying at least one of said provider and said consumer when a said optimal bid is determined.

7. The method of claim 1, further including:
identifying a plurality of consumers, wherein each of said plurality of consumers has provided a purchase indicator similar to said purchase indicator of said consumer;
combining said plurality of consumers and said consumer into a buying group;
calculating a value of said group based on a determination of point-to-currency values of each of said plurality of consumers points.

8. The method of claim 1, further including enabling said provider to sell said item without submitting said bid.

9. The method of claim 1, further including providing said consumer with provider information comprising at least one of company description, client list, stock symbol, biographic information, credit information, and balance sheet information.

10. The method of claim 1, further including generating a report, wherein said report includes bidding statistics relating to at least one of: a period of time, an auction category, provider demographics, consumer demographics, bid amounts, and trends.

11. The method of claim 1, further including receiving bidding rules from said provider, wherein said bidding rules related to at least one of: consumer credit information, brand of points, and consumer transactional history.

12. The method of claim 1, further including receiving bidding rules from said consumer, wherein said auction rules relate to at least one of: company description, client list, stock symbol, biographic information, credit information, and balance sheet information.

13. The method of claim 1, wherein said subset is from at least one of a first loyalty account, a second loyalty account, a consumer loyalty account, a third party loyalty account, a group loyalty account, and a loyalty account based on a consortium of merchants.

14. The method of claim 1, wherein said point balance includes more than one point type.

15. The method of claim 1, wherein said point balance comprises points, wherein each point has a point type and said point type may be based upon points issued from at least one of: a merchant consortium, a merchant, a manufacturer, and an issuer.

16. The method of claim 1, wherein said point balance comprises points, wherein each point has a point type and a different of said point type may be earned during a single transaction.

17. A method for facilitating a point based auction between a consumer and a provider, said method including:
receiving, from said provider, an item, wherein said item is at least one of: a product and a service;
receiving a bid from said consumer, wherein said bid comprises a subset of a point balance that said consumer will provide in exchange for said item;
determining a currency value of said subset;
communicating said currency value to said provider;
determining when said bid is an optimal bid for said item;
deducting said number of loyalty points from an account of said consumer when said bid is an optimal bid, wherein said currency value is unknown to said consumer;
converting said number of loyalty points to said currency value; and,
crediting said currency value to an account of said provider.

18. The method of claim 17, further comprising receiving a referral from said provider, wherein said consumer is directed to said referral when said bid is not an optimum bid.

19. The method of claim 18, wherein said provider is compensated by said referral when said consumer purchases from said referral.

20. The method of claim 19, wherein said compensation is at least one of currency and loyalty points.

21. The method of claim 17, further including enabling said consumer to purchase said item without submitting said bid.

22. The method of claim 17, wherein said point balance includes more than one point type.

23. The method of claim 17, wherein said point balance comprises points, wherein each point has a point type and said point type may be based upon points issued from at least one of: a merchant consortium, a merchant, a manufacturer, and an issuer.

24. The method of claim 17, wherein said point balance comprises points, wherein each point has a point type and a different of said point type may be earned during a single transaction.

25. A computer readable storage medium containing a set of instructions for a general purpose computer for facilitating a point based auction between a consumer and a provider, said instructions including:
receiving, from said provider, an item, wherein said item is at least one of: a product and a service;
determining a currency value of a subset of a point balance belonging to said consumer;
communicating said currency value to said provider;
receiving a bid from said provider based on said currency value;
determining when said bid is an optimal bid for said item;
deducting said subset of said point balance from an account of said consumer when said bid is an optimal bid, wherein said currency value is unknown to said consumer;
converting said number of loyalty points to said currency value; and,
crediting said currency value to an account of said provider.
